(19) United States
(12) Patent Application Publication
(10) Pub. No.: US 2008/0004082 A1
(43) Pub. Date: Jan. 3, 2008

(54) Method and apparatus for displaying user information on an external display

(75) Inventor: Leland Scott Bloebaum, Cary, NC (US)

Correspondence Address: COATS & BENNETT/SONY ERICSSON, 1400 CRESCENT GREEN, SUITE 300, CARY, NC, 27511, US

(73) Assignee: Sony Ericsson Mobile Communications AB

(21) Appl. No.: 11/477,580

(22) Filed: Jun. 29, 2006

(51) Int. Cl. H04B 1/38

(52) U.S. Cl. 455/566; 455/575.3

(57) ABSTRACT

The present invention comprises a mobile device that displays a first subset of user-selected user information on a first display area visible when the mobile device is in an open position. When the mobile device is in a closed position, the mobile device displays a second subset of user-selected user information on a second display area that is smaller than the first display area and that is visible when the mobile device is in the closed position. In some embodiments, the user information comprises activity data corresponding to physical activity of the user.

### BACKGROUND

The present invention relates generally to mobile devices, and more particularly to displaying data on mobile devices.

Clamshell mobile devices are becoming increasing popular due to their small form factor, particularly since newer clamshell designs include a small external display visible when the clamshell is closed. Due to the small size, these external displays typically provide a limited amount of information to the user, such as time, battery level, signal strength, call-specific information, etc. To view additional information, the user must first open the clamshell and view the information on the larger internal display. However, while the user is participating in a physical activity, such as skiing, jogging, inline skating, cycling, etc., it may be inconvenient for the user to open the clamshell and view the information.

### SUMMARY

The present invention comprises a mobile device having first and second housing sections movable relative to one another between open and closed positions. The mobile device further includes a first display area visible when the mobile device is in an open position and a smaller second display area visible when the mobile device is in a closed position. A control circuit operatively connected to the first and second display areas executes a user application to generate a set of user information. When the first and second housing sections are arranged in the open position, the control circuit outputs a first subset of user information to the first display area. When the first and second housing sections are arranged in the closed position, the control circuit outputs a second user-selected subset of the user information to the second display area. A corresponding method is also described.

### BRIEF DESCRIPTION OF THE DRAWINGS

FIGS. 1A and 1B show one exemplary mobile device according to the present invention.

FIG. 2 shows a block diagram for an exemplary mobile device.

FIG. 3 shows an exemplary display control process.

FIGS. 4A and 4B show exemplary menus displayed for enabling user selection of user information.

FIGS. 5A and 5B show another exemplary mobile device according to the present invention.

FIGS. 6A and 6B show another exemplary mobile device according to the present invention.

### DETAILED DESCRIPTION

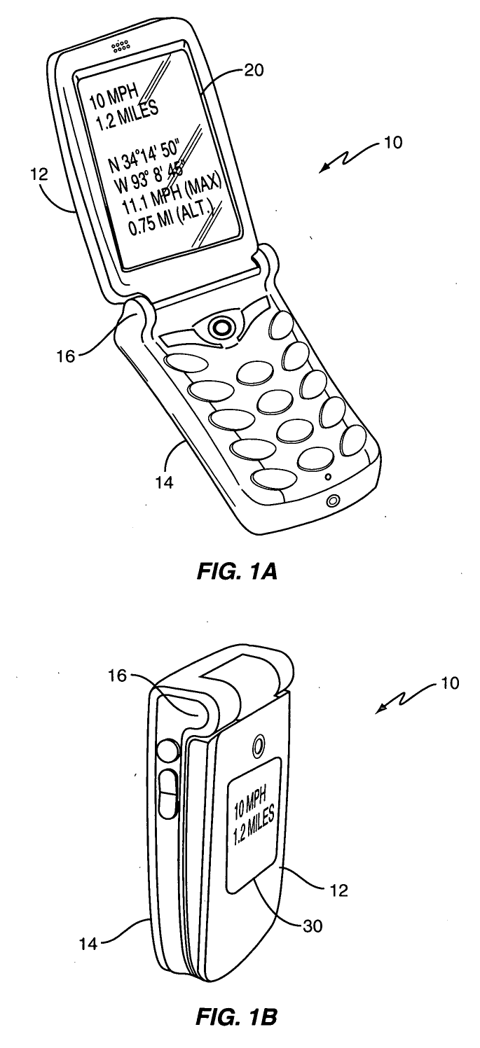

FIGS. 1A and 1B illustrate one exemplary mobile device 10 according to the present invention. Mobile device 10 has a clamshell housing with a first housing section 12 connected to a second housing section 14 by a jointed connector 16, such as a hinge. As shown in FIG. 1A, a first internal display 20 is visible when the first and second housing sections 12, 14 are arranged in an open position. Further, a second external display 30, smaller than internal display 20, is visible when the first and second housing sections 12, 14 are arranged in a closed position, as shown in FIG. 1B.

The external display of a conventional mobile device typically provides a limited amount of space for displaying information. Conventionally, the external display is used to display the current time and limited phone operation data. The larger internal display is used to display information generated by user applications. However, it is sometimes impractical or inconvenient to open the mobile device to view application data. For example, the mobile device may include an application for monitoring a physical activity, such as jogging, skiing, inline skating, cycling, etc. The user may want to view activity data while engaged in the physical activity. According to the present invention, a user application can be configured to output user information to either the internal display 20 or to the external display 30 depending on whether the mobile device 10 is in the open or closed positions. Thus, the user has access to desired user information even when the mobile device 10 is in the closed position.

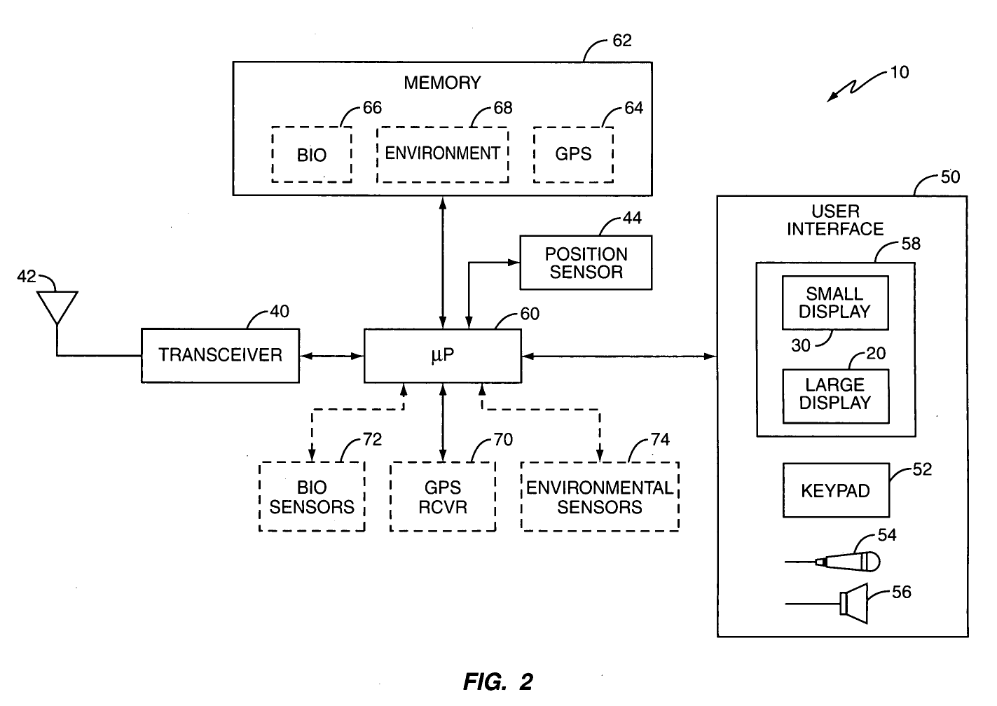

FIG. 2 shows one exemplary block diagram of a mobile device 10 used to implement the present invention. Mobile device 10 includes a long-range wireless transceiver 40 that transmits signals to and receives signals from one or more base stations via antenna 42. The transceiver 40 may operate according to any known standard. Exemplary communication standards include but are not limited to, Code Division Multiple Access (CDMA), Global System for Mobile Communications (GSM), Universal Mobile Telecommunications System (UMTS), Orthogonal Frequency Division Multiplexing (OFDM), etc. Mobile device 10 also includes a position sensor 44, user interface 50, control circuit 60, memory 62, and optional GPS receiver 70. Position sensor 44 detects the relative position of first and second housing sections 12, 14. User interface 50 enables the user to interact with the mobile device 10. The user interface 50 includes a speaker 52, microphone 54, one or more keypad controls 56, and a display system 58, which includes the internal display 20 and external display 30 discussed above. Control circuit 60 performs various processing tasks, including control of the overall operation of mobile device 10, according to programs stored in memory 62, which stores data and programs needed for operation.

A user application 64 that provides information to the user is stored in memory 62 and executed by control circuit 60. User application 64 generates user information intended for output to the user for viewing on displays 20, 30. According to the present invention, the user may select a first subset of user information for output to internal display 20 when the mobile device 10 is in the open position and a second subset of user information for output to external display 30 when the mobile device 10 is in the closed position. The user information displayed when the mobile device 10 is in the closed position may be a subset of the user information that is displayed when the mobile device 10 is in the open position. Alternatively, the user information displayed when mobile device 10 is in the closed position may be different from the user information displayed when the mobile device 10 is in the open position. Control circuit 60 determines whether the first and second housing sections 12, 14 are arranged in the open or closed position based on a control signal provided by position sensor 44. When in the open position, control circuit 60 outputs the first subset of the user information to internal display 20, as shown in FIG. 1A. When in the closed position, control circuit 60 outputs a second subset of the user information to the external display 30, as shown in FIG. 1B. As a result, the user may quickly and easily view desired user information, even when the clamshell housing is arranged in the closed position.

In one exemplary embodiment, user application 64 comprises an application for monitoring a physical activity of the user. The user application 64 receives position data from a GPS receiver 70 or other location-based or satellite navigation system. Application 64 uses the position data to generate location-related activity data for output to displays 20, 30. As used herein, the term “activity data” refers user information that relates to a physical activity engaged in by the user, such as skiing, jogging, cycling, etc. Exemplary location-related activity data includes but is not limited to current velocity, average velocity, geographic location, altitude, bearing, maximum velocity, change in altitude and/or bearing, duration, and a distance traveled. As an example, the application 64 may be a ski application that provides information related to skiing. The activity data generated by the ski application 64 may comprise information such as the location of the skier, the average velocity of the skier during a period of time, the maximum velocity of the skier during a period of time, the distance traveled, and the change in altitude. The application 64 may also record and display the path traveled by the skier. In this example, the user may select a first set of activity data to be displayed on internal display 20, and a second set of activity data to be displayed on external display 30. Depending on whether the mobile device 10 is opened or closed, application 64 outputs either the first set of activity data to internal display 20, or the second set of activity data to external display 30.

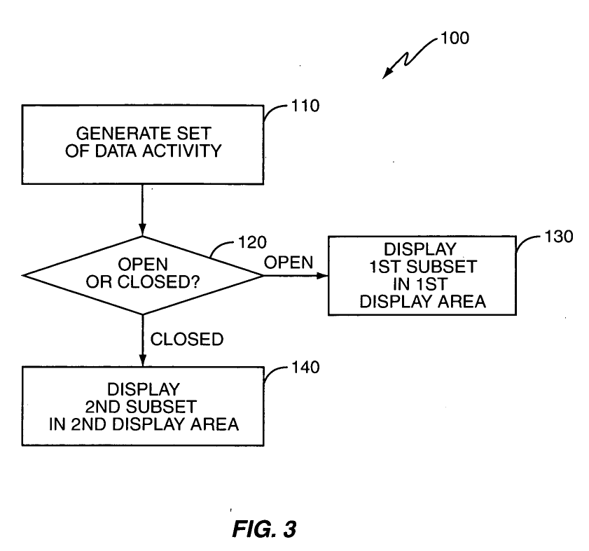

FIG. 3 illustrates exemplary logic for outputting activity data. The user application 64 generates the set of activity data (step 110) and determines whether the first and second housing sections 12, 14 are in the open or closed position based on the signal provided by position sensor 44 (step 120). Application 64 outputs a first subset of the activity data to internal display 20 if the first and second housing sections 12, 14 are arranged in the open position (step 130). If the first and second housing sections 12, 14 are arranged in the closed position, application 64 outputs a second subset of the activity data to external display 30 (step 140). As application 64 receives updated position data from the GPS receiver 70, the application 64 dynamically generates and outputs the updated activity data to either the internal display 20 or the external display 30. As a result, the user may view some of the dynamically updated activity data without opening mobile device 10.

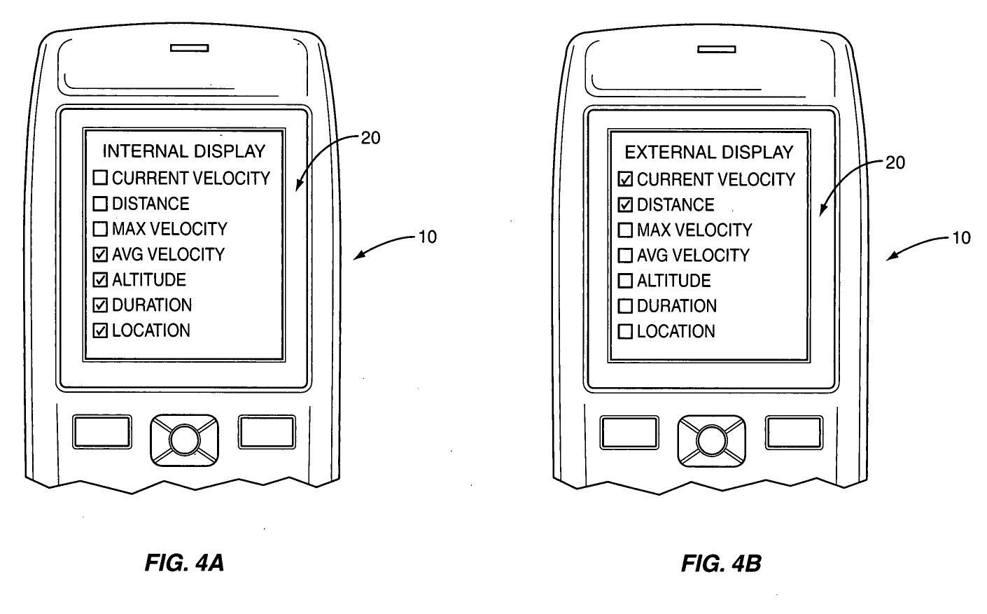

FIGS. 4A and 4B illustrate an exemplary method for configuring the user application 64. In this example, the user accesses a list of display items that can be displayed to the user through a menu. FIG. 4A illustrates display items that may be displayed on the internal display 20. FIG. 4B illustrates display items that may be displayed on the external display 30. The user selects the desired display items for both the internal and external displays 20, 30. Application 64 may limit the number of items that can be selected on one or both displays 20, 30. In the example shown in FIG. 4A, the user selects average velocity, altitude, duration, and location for display on internal display 20 when the mobile device 10 is open. The user selects current velocity and distance for display on external display 30 when the mobile device 10 is closed.

Application 64 may receive input from a variety of sources in addition to or alternatively to the GPS receiver 70. For example, mobile device 10 may further include one or more sensors 72 that monitor physiological characteristics of the user, such as heart rate, temperature, blood pressure, etc. These physiological characteristics, or other derivative biological information determined by biological application 66, may be included in the activity data output to displays 20, 30. As with the location-related activity data, the externally displayed biological-related activity data may be very useful to users participating in a physical activity, such as jogging, cycling, etc.

In another embodiment, mobile device 10 may optionally include an environmental application 68 in memory 62 and one or more environmental condition sensors 74. Application 68 may include code for monitoring and displaying environmental conditions, such as temperature, humidity, wind speed, wind direction, barometric pressure, etc. By pre-configuring mobile device 10 as discussed above, the user may have quick and easy access to at least some of the environmental data, such as temperature and wind speed, even when the clamshell housing is in the closed position. Such environmental data may be important to the user's current activity, i.e., when the user is skiing. It will be appreciated that the control circuit 60 may output any type of user information, including location-related activity data, biological-related activity data, environmental data, or any combination thereof to displays 20, 30.

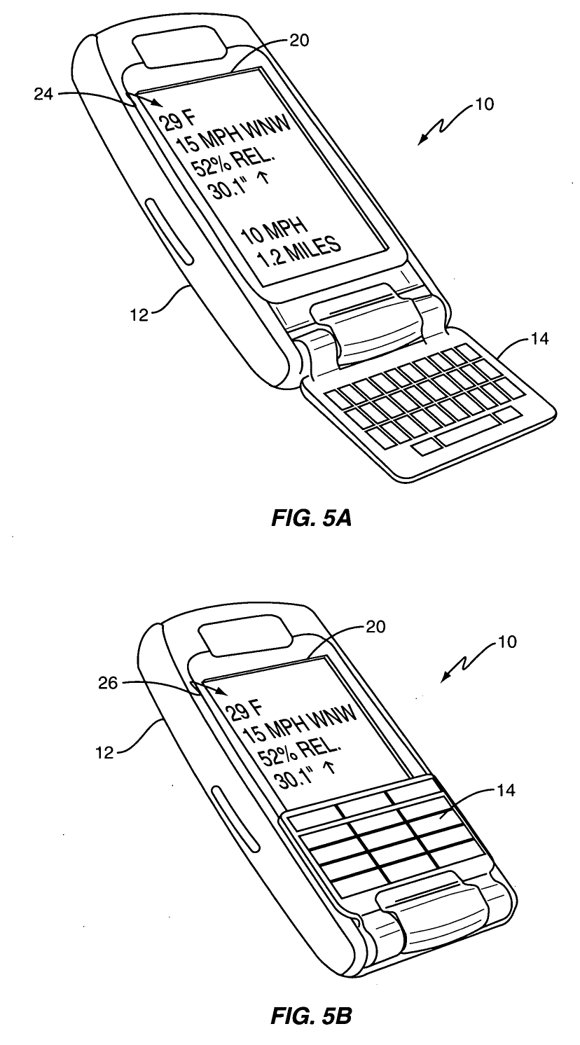

FIGS. 5A and 5B show an alternate mobile device 10 comprising a flip phone 10. Instead of having two separate displays, flip phone 10 comprises one display 20. When flip phone 10 is open, a first display area 24 comprising display 20 is visible (FIG. 5A). However, when flip phone 10 is closed, the second housing section 14 conceals a portion of display 20 (FIG. 5B). As a result, when flip phone 10 is closed, a second display area 26 comprising a portion of display 20 is visible. For this embodiment, control circuit 60 outputs the first subset of user information to the first display area 24 when flip phone 10 is open. When flip phone 10 is closed, control circuit 60 outputs the second subset of user information to the second display area 26.

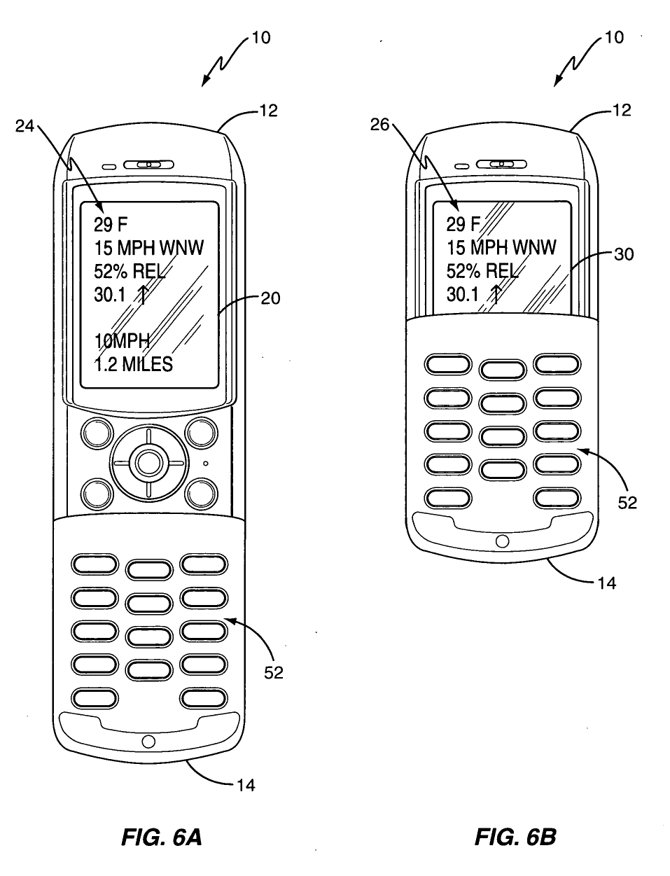

FIGS. 6A and 6B show another alternate mobile device 10 comprising a slider phone 10 having a display 20. When slider phone 10 is open, a first display area 24 comprising the entire display 20 is visible (FIG. 6A). When slider phone 10 is closed (FIG. 6B), the second housing section 14 conceals a portion of display 20, leaving a smaller second display area 26 visible. Control circuit 60 outputs different subsets of activity and/or environmental data on the different display areas 24, 26 based on the open or closed configuration of the slider phone 10. As discussed above, the first and second subsets of user information may include common elements or may include different elements. As such, the user information displayed in the first display area 24 of either the slider phone 10 or flip phone 10 may be different from the user information displayed in the second display area 26.

The above-described mobile device 10 and display control process has advantages over conventional mobile devices having different display areas visible in open and closed positions. For example, using the invention described above, a skier may view the maximum velocity, altitude change, and distance associated with a run down a mountain without having to remove his or her gloves and open the mobile device 10. In another example, a jogger may quickly view his or her average velocity and heart rate while jogging without having to open the mobile device 10. As such, the present invention provides users with an alternative way to view selected activity data even when the mobile device 10 is in a closed configuration.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

1. A mobile device comprising:
first and second housing sections movable relative to one another between an open position and a closed position;
a first display area visible when the first and second housing sections are arranged in the open position;
a second display area smaller than the first display area and visible when the first and second housing sections are arranged in the closed position; and
a control circuit configured to:
execute a user application to generate a set of user information;
output a first subset of user information to the first display area when the first and second housing sections are arranged in the open position; and
output a second user-selected subset of user information to the second display area when the first and second housing sections are arranged in the closed position.

2. The mobile device of claim 1 wherein the set of user information comprises a set of activity data, wherein the first subset of user information comprises a first subset of activity data, and wherein the second user-selected subset of user information comprises a second user-selected subset of activity data.

3. The mobile device of claim 2 wherein the user application comprises a location application, and wherein the set of activity data includes at least one of a current velocity, maximum velocity, distance, bearing, bearing change, altitude, altitude change, duration, and geographic location.

4. The mobile device of claim 2 wherein the user application comprises a biological application, and wherein the set of activity data includes at least one of a heart rate, blood pressure, and body temperature.

5. The mobile device of claim 1 wherein the user application comprises an environmental application, wherein the set of user information comprises a set of environmental data, and wherein the first subset of user information and the second user-selected subset of user information comprises a first set of environmental data and a second user-selected subset of environmental data, respectively.

6. The mobile device of claim 5 wherein the set of environmental data includes at least one of an external temperature, humidity, wind speed, wind direction, and barometric pressure.

7. The mobile device of claim 1 wherein the first display area comprises a first display that is visible when the first and second housing sections are arranged in the open position and concealed when the first and second housing sections are arranged in the closed position, and wherein the second display area comprises a second display that is smaller than the first display and is visible when the first and second housing sections are arranged in the closed position.

8. The mobile device of claim 1 wherein the first and second display areas comprise different portions of the same display.

9. The mobile device of claim 8 wherein the first display area comprises a portion of the display that is visible when the first and second housing sections are arranged in the open position, and wherein the second display area comprises a portion of the display that is visible when the first and second housing sections are arranged in the closed position.

10. The mobile device of claim 8 wherein the first and second display areas at least partially overlap on the display.

11. The mobile device of claim 1 wherein the second user-selected subset of user information comprises a user-selected subset of the first subset of user information.

12. The mobile device of claim 1 wherein the first subset of user information comprises a first user-selected subset of user information.

13. The mobile device of claim 1 wherein the control circuit is configured to generate user information related to a skiing activity.

14. The mobile device of claim 1 wherein the first and second housing sections are connected by one of a pivot connector, a slider connector, and a rotatable connector.

15. The mobile device of claim 1 wherein the control circuit is further configured to dynamically update the displayed user information.

16. A method of dynamically updating information displayed on a mobile device having first and second housing sections connected and movable relative to one another between an open position and a closed position, the method comprising:
executing a user application to generate a set of user information;
displaying a first subset of user information on a first display area visible when the first and second housing sections are arranged in the open position; and
displaying a second user-selected subset of user information on a second display area smaller than the first display area and visible when the first and second housing sections are arranged in the closed position.

17. The method of claim 16 wherein the set of user information comprises a set of activity data, wherein the first subset of user information comprises a first subset of activity data, and wherein the second user-selected subset of user information comprises a second user-selected subset of activity data.

18. The method of claim 17 wherein executing the user application comprises executing a location application, and wherein the set of activity data comprises at least one of a current velocity, average velocity, maximum velocity, distance, altitude, altitude change, and geographic location.

19. The method of claim 17 wherein executing the user application comprises executing a biological application, and wherein the set of activity data comprises at least one of a heart rate, blood pressure, and body temperature.

20. The method of claim 16 wherein executing the user application comprises executing an environmental application, wherein the set of user information comprises a set of environmental data, and wherein the first subset of user information and the second user-selected subset of user information comprises a first set of environmental data and a second user-selected subset of environmental data, respectively.

21. The method of claim 20, wherein the set of environmental data comprises at least one of an external temperature, humidity, wind speed, wind direction, and barometric pressure.

22. The method of claim 16 wherein the first display area comprises a first display that is visible when the first and second housing sections are arranged in the open position and concealed when the first and second housing sections are arranged in the closed position, and wherein the second display area comprises a second display that is smaller than the first display and is visible when the first and second housing sections are arranged in the closed position.

23. The method of claim 16 wherein displaying the first subset of user information comprises displaying a first user-selected subset of user information on the first display area visible when the first and second housing sections are arranged in the open position.

24. The method of claim 16 wherein the first and second display areas comprise different portions of the same display.

25. The method of claim 24 wherein the first display area comprises a portion of the display that is visible when the first and second housing sections are arranged in the open position, and wherein the second display area comprises a portion of the display that is visible when the first and second housing sections are arranged in the closed position.

26. The method of claim 16 further comprising dynamically updating the displayed user information.

27. A method of dynamically updating information displayed on a mobile device having first and second housing sections connected and movable relative to one another between an open position and a closed position, the method comprising:
executing a user application to generate a set of activity data;
displaying a first subset of activity data on a first display area visible when the first and second housing sections are arranged in the open position; and
displaying a second subset of activity data on a second display area smaller than the first display area and visible when the first and second housing sections are arranged in the closed position.

28. The method of claim 27 wherein executing the user application comprises executing a location application, and wherein the set of activity data comprises at least one of a current velocity, average velocity, maximum velocity, distance, altitude, altitude change, and geographic location.

29. The method of claim 27 wherein executing the user application comprises executing a biological application, and wherein the set of activity data comprises at least one of a heart rate, blood pressure, and body temperature.

30. The method of claim 27 further comprising executing an environmental application to generate a set of environmental data comprising at least one of an external temperature, humidity, wind speed, wind direction, and barometric pressure

31. The method of claim 27 further comprising selecting at least one of the first and second subsets of activity data responsive to user input.
